(19) United States
(12) Patent Application Publication
(10) Pub. No.: US 2012/0117006 A1
(43) Pub. Date: May 10, 2012

(54) METHOD AND APPARATUS FOR BUILDING A USER BEHAVIOR MODEL

(75) Inventor: Sailesh Kumar Sathish, Tampere (FI)

(73) Assignee: Nokia Corporation

(21) Appl. No.: 12/939,661

(22) Filed: Nov. 4, 2010

(51) Int. Cl. G06F 15/18

(52) U.S. Cl. 706/12

(57) ABSTRACT

An apparatus may include a monitoring module configured to monitor user interactions by a user with applications. A contextual characteristics determiner may determine one or more contextual characteristics relating to the user interactions, and the contextual characteristics may be categorized based on an ontology model. Thereby, a data model builder may build a user behavior model for the user based at least in part on the user interactions and the contextual characteristics. The apparatus may provide for private storage of the user behavior module. A recommendation module may issue a recommendation, which may be mapped to one of the applications, based at least in part on the user behavior model. The recommendation may be issued in response to a query from a query module. The query may include current contextual characteristics of the user and/or the apparatus.

### TECHNOLOGICAL FIELD

An example embodiment of the present invention relates generally to techniques for building a user behavior model and, more particularly, relates to an apparatus, a method and a computer program product for monitoring user interactions by a user with applications, determining contextual characteristics relating to the user interactions, and building a user behavior model based at least in part thereon.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or contacts, receive services and/or share information, media and other content.

Some of the technologies which are becoming more popular are that of location based services and other personalized services. In this regard, some technologies may provide users of properly equipped mobile terminals with content which is specific to the present location of the user or other contextual information. Thus, for example, the user may be provided with weather information relating to the user's present location. Thereby, content may be provided to the user which may be relevant to the user's interest and current context. However, privacy of user information may be an issue and interests of users may be difficult to determine.

### BRIEF SUMMARY

A method, apparatus and computer program product are therefore provided that may build a user behavior model while maintaining control over user information.

In an example embodiment, an apparatus comprises at least one processor and at least one memory including computer program code, the at least one memory and the computer program code configured to, with the processor, cause the apparatus to monitor one or more user interactions by a user with one or more applications and determine one or more contextual characteristics relating to the user interactions. The apparatus may thereby build a user behavior model for the user based at least in part on the user interactions and the contextual characteristics.

In an additional example embodiment a method comprises monitoring one or more user interactions by a user with one or more applications and determining one or more contextual characteristics via a processor relating to the user interactions. Further, the method may include building a user behavior model for the user based at least in part on the user interactions and the contextual characteristics.

In a further example embodiment a computer program product comprises at least one computer-readable storage medium having computer-executable program code portions stored therein, the computer-executable program code portions comprising program code instructions for monitoring one or more user interactions by a user with one or more applications and program code instructions for determining one or more contextual characteristics relating to the user interactions. Additionally, the computer program product may comprise program code instructions for building a user behavior model for the user based at least in part on the user interactions and the contextual characteristics.

In a further example embodiment an apparatus comprises means for monitoring one or more user interactions by a user with one or more applications and means for determining one or more contextual characteristics relating to the user interactions. Additionally, the apparatus may include means for building a user behavior model for the user based at least in part on the user interactions and the contextual characteristics.

In some embodiments a recommendation may be issued based at least in part on the user behavior model. The recommendation may be issued in response to a query, which may comprise one or more current contextual characteristics. Further, the recommendation may be mapped to one of the applications. Also, the contextual characteristics may be categorized based on an ontology model. Additionally, the user behavior model may be privately stored.

User interface circuitry may also be provided which is configured to facilitate user control of at least some functions through use of a display. The user interface circuitry may cause at least a portion of a user interface to be displayed on the display to facilitate user control of at least some functions. Accordingly, embodiments of the present invention may provide a way to build user behavior models based on user interactions with applications and related contextual characteristics. Thus, application recommendations may be improved while also maintaining privacy.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus configured to build a user behavior model for a user according to an example embodiment of the present invention;

FIG. 3 illustrates a schematic block diagram of an embodiment of the apparatus of FIG. 2 including additional components configured to build a user behavior model for a user according to an example embodiment of the present invention; and

FIG. 4 illustrates a flowchart of the operations performed in building a user behavior model for a user according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a computer-readable storage medium, which refers to a non-transitory, physical storage medium (e.g., volatile or non-volatile memory device), can be differentiated from a computer-readable transmission medium, which refers to an electromagnetic signal.

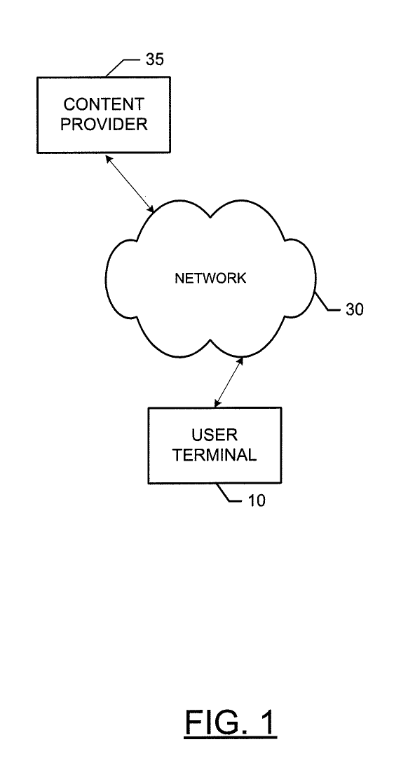

As indicated above, some embodiments of the present invention may be employed in methods, apparatuses and computer program products configured to build a user behavior model. In this regard, for example, FIG. 1 illustrates a block diagram of a system that may benefit from embodiments of the present invention. It should be understood, however, that the system as illustrated and hereinafter described is merely illustrative of one system that may benefit from an example embodiment of the present invention and, therefore, should not be taken to limit the scope of embodiments of the present invention.

As shown in FIG. 1, a system in accordance with an example embodiment of the present invention may include a user terminal 10. The user terminal 10 may be any of multiple types of fixed or mobile communication and/or computing devices such as, for example, personal digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, which employ an embodiment of the present invention.

In some embodiments the user terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal and/or the other devices may be enabled to communicate with each other, for example, according to numerous communication protocols including Hypertext Transfer Protocol (HTTP) and/or the like, to thereby carry out various communication or other functions of the user terminal and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The user terminal 10 may be configured to execute applications and thereby output text, pictures, data, audio, video, and/or various other embodiments of content. The users may also employ the applications to perform various functions such as a calculator function. Thereby, users may employ the user terminal 10 to interact with various types of content and perform various functions through execution of one or more applications.

In some embodiments content may be provided to the applications on the user terminal 10 by one or more content providers 35. In some embodiments each of the content providers 35 may be embodied as a server, server bank or other computer or other computing device or node configured to provide content to the user terminal 10. Each of the content providers 35 may have any number of functions or associations with various services. As such, for example, each of the content providers 35 may be a platform such as a dedicated server (or server bank), or each of the content providers may be a backend server associated with one or more other functions or services. Thus, the content providers 35 may provide various types and forms of content to the user terminal 10 for output by applications.

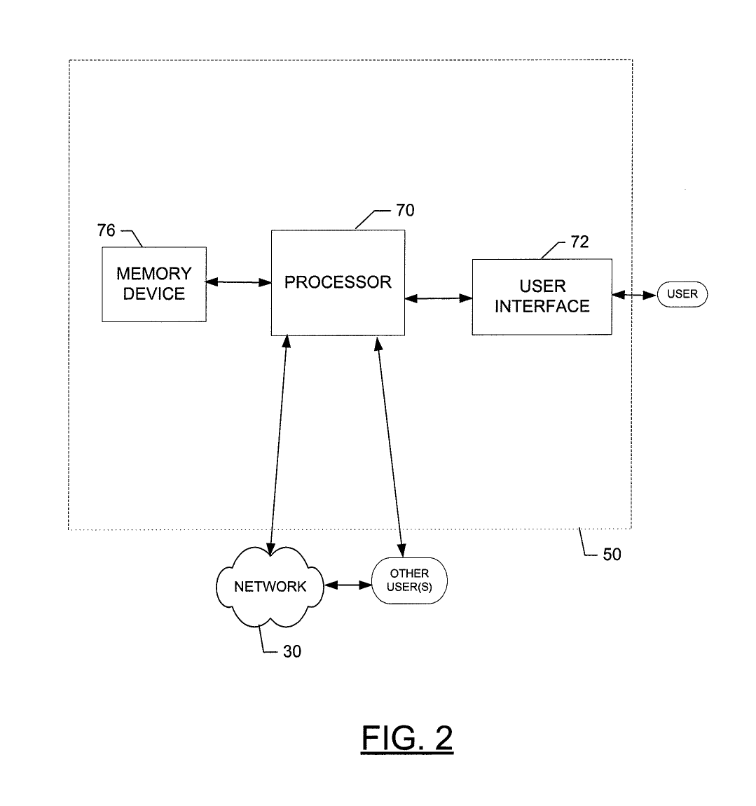

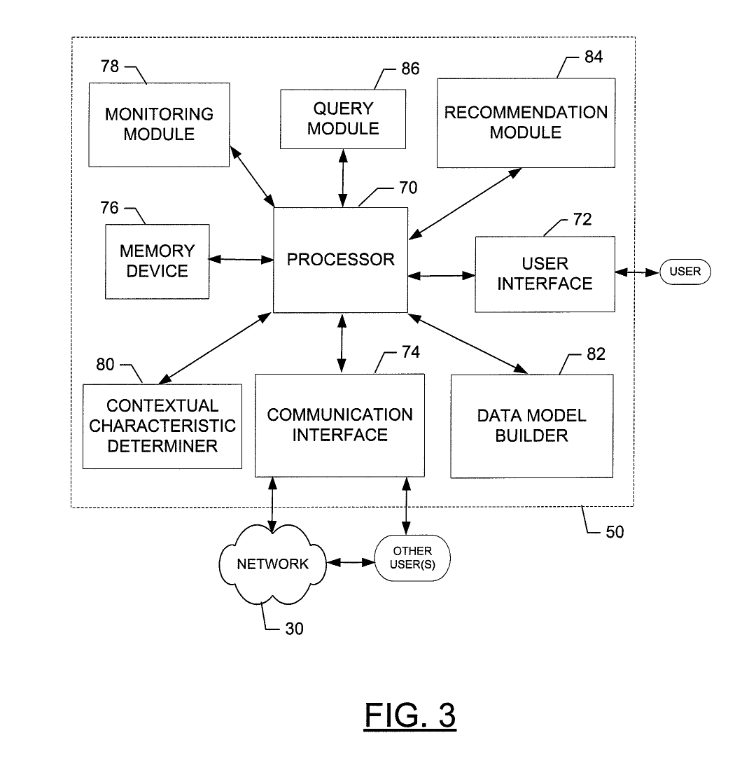

In example embodiments illustrated in FIGS. 2 and 3, an apparatus 50 is provided that may be employed by devices performing example embodiments of the present invention. The apparatus 50 may be embodied, for example, as any device hosting, including, controlling, comprising, or otherwise forming a portion of the user terminal 10 and/or the content providers 35. However, embodiments may also be embodied on a plurality of other devices such as for example where instances of the apparatus 50 may be embodied on the network 30. As such, the apparatus 50 of FIGS. 2 and 3 is merely an example and may include more, or in some cases less, than the components shown in FIGS. 2 and 3.

With further regard to FIGS. 2 and 3, the apparatus 50 may be configured to build a user behavior model. As depicted in FIG. 2, the apparatus 50 may include or otherwise be in communication with a processor 70, a user interface 72, and a memory device 76. The memory device 76 may include non-transitory and tangible memory that may be, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70.

As mentioned above, the apparatus 50 may, in some embodiments, be a user terminal or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or other hardware processor. In an example embodiment, the processor 70 may be configured to execute instructions stored in the memory device 76 or otherwise accessible to the processor. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor to perform the algorithms and/or operations described herein when the instructions are executed. However, in some cases, the processor 70 may be a processor of a specific device (for example, a user terminal or network device such as a server) adapted for employing embodiments of the present invention by further configuration of the processor by instructions for performing the algorithms and/or operations described herein. The processor 70 may include, among other things, a clock, an arithmetic logic unit (ALU) and logic gates configured to support operation of the processor.

The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, or other input/output mechanisms.

The processor 70 may comprise user interface circuitry configured to control at least some functions of one or more elements of the user interface 72, such as, for example, the speaker, the ringer, the microphone, the display, and/or the like. The processor 70 and/or user interface circuitry comprising the processor 70 may be configured to control one or more functions of one or more elements of the user interface 72 through computer program instructions (for example, software and/or firmware) stored on a memory accessible to the processor 70 (for example, memory device 76, and/or the like).

As mentioned above, embodiments of the apparatus 50 may include more, or in some cases less, than the components shown in FIG. 2. In this regard, FIG. 3 illustrates an embodiment of the apparatus 50 comprising additional components configured to build a user behavior model. The apparatus 50 may include or otherwise be in communication with the processor 70, the user interface 72, and the memory device 76 as described above with respect to FIG. 2.

In some embodiments the apparatus 50 may further comprise a communication interface 74. The communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

In some embodiments the apparatus 50 may further include a monitoring module 78. The processor 70 or other circuitry may be embodied as, include or otherwise control the monitoring module 78. The monitoring module 78 may be configured to monitor one or more one or user interactions by a user with one or more applications. The monitoring module 78 may thereby provide for storage of user interaction data in the memory device 76, for example.

In one embodiment, monitoring user interactions with the applications may include monitoring user interactions that open and close applications. Thus, in one embodiment the monitoring module 78 may monitor application usage by the user by tracking instances in which the user opens and closes the applications. However, in other embodiments the monitoring module 78 may monitor other user interactions with the applications. For example, the monitoring module 78 may monitor user interactions with various functions provided within the applications. Further, the monitoring module 78 may in some embodiments also monitor user interactions with content provided to the user by applications. For example, the monitoring module 78 may monitor selection and viewing of content.

Thus, user interactions, as used herein, may refer to user inputs, or other interaction with the applications and/or content provided by the application. User interactions may include standard document object model (DOM) events obtained through user interaction with a web page, though they are not limited thereto. Thus, for example, when a user clicks on a function within an application or selects content within the application, the monitoring module 78 may monitor this activity in some embodiments. Conversely, user interactions may also comprise the lack of a user action. For example, if a user does not open an application or does not click on or otherwise interact with content provided by an application, the monitoring module 78 may monitor this lack of activity. However, as noted above, in some embodiments the monitoring module 78 may monitor more or less user interactions. For example, in one embodiment the monitoring module 78 may monitor user interactions that open and close applications, and the names (or other identifiers) of the applications which are opened and closed. Thus, in some embodiments the monitoring module 78 may record application usage data.

In embodiments in which user interactions within the applications are monitored, as opposed to only monitoring opening and closing of applications and the names (or other identifiers) thereof, the applications may be configured to provide data relating to the user interactions to the monitoring module 78. For example, the applications may be initially programmed to provide data relating to the user interactions to the monitoring module 78. Alternatively, the monitoring module 78 may be configured to insert a script into the applications (or content provided therewith) that provides the user interaction data to the monitoring module. However, in embodiments which only monitor user interactions that open and close the applications, and the names (or other identifiers) of the applications, customization of the applications or insertion of a script may not be required.

In some embodiments the apparatus 50 may further include a contextual characteristic determiner 80. The processor 70 or other circuitry may be embodied as, include or otherwise control the contextual characteristic determiner 80. The contextual characteristic determiner 80 may be configured to determine one or more contextual characteristics. In some embodiments the contextual characteristic determiner 80 may be configured to determine contextual characteristics relating to the user interactions. For example, the contextual characteristic determiner 80 may be configured to determine contextual characteristics of the apparatus 50 and/or the user at the time of the user interactions which are monitored by the monitoring module 78. Contextual characteristics may include the present time, location, activity, age, etc. of the user and/or the apparatus 50. Information relating to the location of the user may, for example, be provided by a GPS module, though location information may additionally or alternatively be provided through other means such as triangulation using cell phone towers in some embodiments.

In some embodiments the contextual characteristic determiner 80 may be configured to categorize the contextual characteristics which are determined. For example, the contextual characteristic determiner 80 may determine that the time at which a user opened an application is 8:30 AM. The contextual characteristic determiner 80 may thus categorize this contextual characteristic into the category of “morning.” By way of further example, the contextual characteristic determiner 80 may determine that the user was at a specific location at the time of opening the application. The contextual characteristic determiner 80 may categorize the location if it corresponds to known locations of significance, such as home, work, a child's school, etcetera. Further, if the contextual characteristic determiner 80 determines that the user is moving, the mode of transportation, such as walking, biking, in a car, on a train, etcetera may be categorized based on determined speed, road and rail maps, and other information. Accordingly, in some embodiments the contextual characteristics may be compartmentalized into certain categories, and hence the contextual characteristics may be potentially more useful for building a user behavior model, as will be discussed below. In some embodiments the categories may be based on an ontology model such that standardized terminology may be employed for the contextual characteristics.

In some embodiments the apparatus 50 may further include a data model builder 82. The processor 70 or other circuitry may be embodied as, include or otherwise control the data model builder 82. The data model builder 82 may be configured to build a user behavior model for the user based at least in part on the user interactions and the contextual characteristics. As will be discussed below, the user behavior model may be employed in issuing recommendations for the user.

In some embodiments the data model builder 82 may build the user behavior model in the form of a matrix. For example, the user behavior model may comprise a matrix factorization model. The matrix may comprise user interaction data as one vector, which may be provided by the monitoring module 78, as described above. Further, the matrix may comprise contextual characteristics as another vector, which may be provided by the contextual characteristic determiner 80, as described above. Thus, for example, in one embodiment the matrix may comprise user interaction data indicating application usage for each application (e.g., the user interaction vector) and corresponding contextual characteristics (e.g., the contextual characteristics vector) which are determined to exist at the time of the user interactions. Accordingly, the user behavior model built by the data model builder 82 may reflect user preference for the user of the apparatus 50 by compiling data on past application usage by the user.

Note that as used herein, the term “user” refers to a single person, or a single device. Thus, for example, in one embodiment the data model builder 82 may build a user behavior model relating to user interactions by all persons using the apparatus 50. However, in other embodiments the data model builder 82 may build a user behavior model relating to user interactions for a single person. For example, the apparatus 50 may request or require that each person login so that the identity of the person interacting with applications is known and thereby the user behavior model may relate only to that person. Further, in embodiments in which the user interactions are recorded for single persons, this information may be, for example, stored in one dataset for all of the persons. However, the dataset may be separable based on the identities of the persons such that unique user behavior models may be provided for each person in some embodiments. Alternatively, separate datasets may be used for each user behavior model when user behavior models are recorded for multiple people.

The user behavior model built by the data model builder 82 may be privately stored. For example, the user behavior model may be stored in the memory device 76 or other local memory. Alternatively, the user behavior model may be stored remotely, but still remain privately stored. For example, the remotely stored user behavior model may only be accessible by the user. Thereby, the information in the user behavior model may remain private.

In some embodiments the apparatus 50 may further include a recommendation module 84. The processor 70 or other circuitry may be embodied as, include or otherwise control the recommendation module 84. The recommendation module 84 may be configured to issue a recommendation based at least in part on the user behavior model. For example, the recommendation module 84 may use current contextual characteristics of the apparatus 50 and/or the user of the apparatus, as may be determined by the contextual characteristic determiner 80, to determine which applications have been used under previously recorded contextual characteristics which are similar to the current contextual characteristics. Thus, in one embodiment the recommendation module 84 may search the user behavior model (e.g., by searching the contextual characteristic vector) for similar contextual characteristics, and then recommend one or more applications (e.g., from the user interaction vector) which have been used under similar circumstances (as reflected by the contextual characteristics). The recommendation module may alternatively or additionally recommend content for output and/or functions for performance by the application in some embodiments depending on what user interaction data has been recorded in the user behavior model.

In some embodiments the apparatus 50 may further include a query module 86. The processor 70 or other circuitry may be embodied as, include or otherwise control the query module 86. The query module 86 may be configured to query the recommendation model 84 for a recommendation. Thus, in some embodiments the recommendation module 84 may issue the recommendation in response to a query from the query module 86. For example, the query module 86 may issue a query comprising one or more current contextual characteristics, as may be determined by the contextual characteristic determiner 80.

By way of example, if the user frequently uses a news application when he returns home from work in the evening, this may be reflected in the user behavior model. Thereby, the recommendation module 84 may respond to a query from the query module 86 by recommending use of the news application to the user when the contextual characteristic determiner 80 determines that the user is at home during the evening. This may occur, for example, when the query issued by the query module 86 does not specify a particular application for use. Instead, the query module 86 may provide the recommendation module 84 with a list of available applications from which to select, or the recommendation module 84 may select from the applications with which user interactions have been previously monitored.

Alternatively, the query module 86 may request a recommendation for a type or category of application, and the query module may then map the recommendation provided by the recommendation module 84 to a particular application. For example, if the recommendation module 84 recommends a news application, the query module 86 may select an application in this category from a list of available applications. The selection by the query module 86 may be based on application profile information associated with the applications. Thus, the recommendation module 84 may directly map the recommendation to an application (e.g. by recommending a particular application), or the query module 86 may map the recommendation to an application (e.g. by selecting the application based on the recommendation and application profile information).

By way of further example, the query module 86 may request a recommendation for a type or category of content for output and/or a function to be performed by an application in embodiments in which the monitoring module 78 monitors user interactions within applications. In such embodiments the query module 86 may select an application from the list of available applications based on application profile data associated therewith. For example, the application profile data may indicate categories of content which are outputted as well as functions performed by the applications in some embodiments.

By way of additional example, the query module 86 may request a recommendation for a type or category of content for output and/or a function to be performed by a specified application. For example, the query module may issue a query for a recommendation for content/functions for an open application which the user is currently using. In such embodiments the query module 86 may provide the recommendation module 84 with constraints in the query limiting the recommendation to certain types or categories of content and/or types of functions which the specified application is configured to perform. Alternatively, the query may specify the name of the application (or other identifier) and the recommendation module 84 may select from the types of content and functions previously used with the application as recorded in the user behavior model. Thereby, the recommendation issued by the recommendation module 84 may be tailored for one or more specified applications in some embodiments.

Note that since the user behavior model may be privately stored (e.g., in the memory device 76), and the recommendation module 84 and query module 86 may be embodied on the apparatus 50, user information may be maintained in privacy. Thereby, relatively greater control may be maintained over information relating to user preferences and activities. For example, exporting of user interaction data and associated contextual characteristics to external servers may not be required. Further, the user behavior model may be relatively more accurate than other models because the data on which the user behavior model is based may be particular to the user.

As a further note, the query, the recommendation, the application profile data, the contextual characteristics, and other information and data processed or otherwise employed by the apparatus 50 may be formatted to fit an ontology model. In this regard, for example, the recommendation from the recommendation module 84 may recommend a category of an application for use, such as “sports news” which may be a term from the ontology model. The application profile data may be formatted using the same ontology model such that any applications relating to this category may be identified based on the terminology within the ontology model. Thus, by standardizing the terminology employed by the various modules of the apparatus 50, recommendations may be improved so as to identify relevant applications, content, and/or functions.

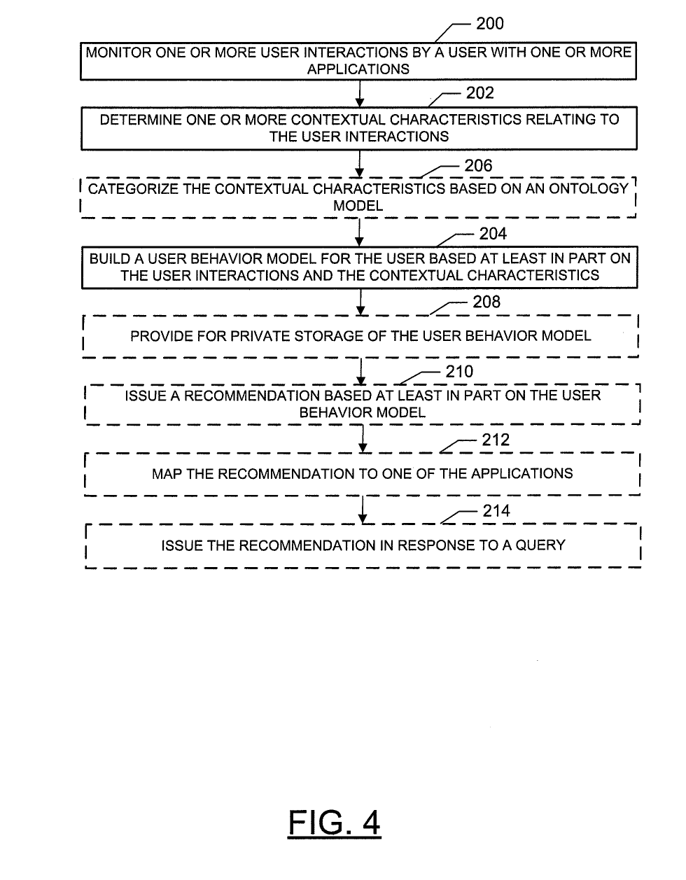

In terms of methods associated with embodiments of the present invention, the above-described apparatus 50 or other embodiments of apparatuses may be employed. In this regard, FIG. 4 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method may include monitoring one or more user interactions by a user with one or more applications at operation 200. Further, the method may include determining one or more contextual characteristics relating to the user interactions at operation 202. Additionally, the method may include building a user behavior model for the user based at least in part on the user interactions and the contextual characteristics at operation 204.

In some embodiments, certain ones of the above-described operations (as illustrated in solid lines in FIG. 4) may be modified or further amplified. In some embodiments additional operations may also be included (some examples of which are shown in dashed lines in FIG. 4). It should be appreciated that each of the modifications, optional additions or amplifications may be included with the above-described operations (200-204) either alone or in combination with any others among the features described herein. As such, each of the other operations as will be described herein may be combinable with the above-described operations (200-204) either alone or with one, more than one, or all of the additional operations in any combination.

For example, the method may also include categorizing the contextual characteristics based on an ontology model at operation 206. Further, the method may include providing for private storage of the user behavior model at operation 208. Additionally, the method may include issuing a recommendation based at least in part on the user behavior model at operation 210. In some embodiments the method may further comprise mapping the recommendation to one of the applications at operation 212. Further, as illustrated at operation 214, the method may include issuing the recommendation in response to a query. The query may comprise one or more current contextual characteristics in some embodiments.

In an example embodiment, an apparatus for performing the method of FIG. 4 and other methods described above may comprise a processor (for example, the processor 70) configured to perform some or each of the operations (200-214) described above. The processor may, for example, be configured to perform the operations (200-214) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-214 may comprise, for example, the processor 70, the user interface 72, the communication interface 74, the monitoring module 78, the contextual characteristic determiner 80, the data model builder 82, the recommendation module 84, and the query module 86, as described above. However, the above-described portions of the apparatus 50 as they relate to the operations of the method illustrated in FIG. 4 are merely examples, and it should be understood that various other embodiments may be possible.

In some embodiments the operation 200 of monitoring one or more user interactions by a user with one or more applications may be conducted by means, such as the user interface 72, the monitoring module 78 and/or the processor 70. Further, the operation 202 of determining one or more contextual characteristics relating to the user interactions may be conducted by means, such as the monitoring module 78, the contextual characteristic determiner 80, and/or the processor 70. Additionally, the operation 204 of building a user behavior model for the user based at least in part on the user interactions and the contextual characteristics may be conducted by means, such as the monitoring module 78, the contextual characteristic determiner 80, the data model builder 82, and/or the processor 70.

Also, the operation 206 of categorizing the contextual characteristics relating to the user interactions may be conducted by means, such as the monitoring module 78, the contextual characteristic determiner 80, the data model builder 82, and/or the processor 70. Additionally, the operation 208 of providing for private storage of the user behavior model may be conducted by means, such as the data model builder 82, the memory device 76, and/or the processor 70. Further, the operation 210 of issuing a recommendation based at least in part on the user behavior model, the operation 212 of mapping the recommendation to one of the applications, and the operation 214 of issuing the recommendation in response to the query may be conducted by means, such as the data model builder 82, the recommendation module 84, the query module 86, and/or the processor 70.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to:
monitor one or more user interactions by a user with one or more applications;
determine one or more contextual characteristics relating to the user interactions; and
build a user behavior model for the user based at least in part on the user interactions and the contextual characteristics.

2. The apparatus of claim 1, further configured to issue a recommendation based at least in part on the user behavior model.

3. The apparatus of claim 2, further configured to issue the recommendation in response to a query.

4. The apparatus of claim 2, further configured to map the recommendation to one of the applications.

5. The apparatus of claim 1, further configured to categorize the contextual characteristics based on an ontology model.

6. The apparatus of claim 1, further configured to provide for private storage of the user behavior model.

7. The apparatus of claim 1, further comprising user interface circuitry configured to:
facilitate user control of at least some functions of the apparatus through use of a display; and
cause at least a portion of a user interface of the apparatus to be displayed on the display to facilitate user control of at least some functions of the apparatus.

8. A method, comprising:
monitoring one or more user interactions by a user with one or more applications;
determining one or more contextual characteristics via a processor relating to the user interactions; and
building a user behavior model for the user based at least in part on the user interactions and the contextual characteristics.

9. The method of claim 8, further comprising issuing a recommendation based at least in part on the user behavior model.

10. The method of claim 9, further comprising issuing the recommendation in response to a query.

11. The method of claim 10, wherein the query comprises one or more current contextual characteristics.

12. The method of claim 9, further comprising mapping the recommendation to one of the applications.

13. The method of claim 8, further comprising categorizing the contextual characteristics based on an ontology model.

14. The method of claim 8, further comprising providing for private storage of the user behavior model.

15. A computer program product comprising at least one computer-readable storage medium having computer-executable program code portions stored therein, the computer-executable program code portions comprising:
program code instructions for monitoring one or more user interactions by a user with one or more applications;
program code instructions for determining one or more contextual characteristics relating to the user interactions; and
program code instructions for building a user behavior model for the user based at least in part on the user interactions and the contextual characteristics.

16. The computer program product of claim 15, further comprising program code instructions for issuing a recommendation based at least in part on the user behavior model.

17. The computer program product of claim 16, further comprising program code instructions for issuing the recommendation in response to a query.

18. The computer program product of claim 16, further comprising program code instructions for mapping the recommendation to one of the applications.

19. The computer program product of claim 15, further comprising program code instructions for categorizing the contextual characteristics based on an ontology model.

20. The computer program product of claim 15, further comprising program code instructions providing for private storage of the user behavior model.
